(19) United States
(12) Patent Application Publication
(10) Pub. No.: US 2025/0165236 A1
(43) Pub. Date: May 22, 2025

(54) SYSTEM PROGRAM OPTIMIZATION DEVICE, SYSTEM PROGRAM OPTIMIZATION SYSTEM, AND COMPUTER-READABLE STORAGE MEDIUM

(71) Applicant: FANUC CORPORATION, Yamanashi (JP)

(72) Inventor: Ryousuke TAIRA, Yamanashi (JP)

(21) Appl. No.: 18/841,389

(22) PCT Filed: Mar. 25, 2022
(86) PCT No.: PCT/JP2022/014623

§ 371 Date: Aug. 26, 2024

(51) Int. Cl. G06F 8/41

(52) U.S. Cl. CPC G06F 8/443

(57) ABSTRACT

This system program optimization system is provided with an information processing device and a system program optimization device. The information processing device receives a setting of a constant value with respect to an external input signal inputted from an external device connected to a numerical control device, and outputs the constant value to a system program optimization device. The system program optimization device acquires the constant value set to the external input signal inputted from the external device connected to the numerical control device, compiles a source code of a system program into an object program which can be executed by the numerical control device, and optimizes the system program by the constant value of the external input signal in the compilation.

### TECHNICAL FIELD

The present invention relates to a system program optimization device, a system program optimization system, and a computer-readable storage medium.

### BACKGROUND ART

Currently, there is program optimization technology. Optimization is a process for making programs more efficient to shorten an execution time and reduce an execution load. The optimization decreases the number of memory runs, enables the use of faster instructions, enables the efficient use of memory hierarchy, and enables the use of highly parallel memory.

The number of instruction executions can be decreased by removal of common subexpressions, constant convolution, constant propagation, removal of loop invariant expressions, removal of inductive variables, reduction of operator strength, loop expansion, loop fusion, removal of non-executed instructions, propagation of copies, code winding, specialization of procedure calls, use of properties of expressions, etc.

In order to use the memory hierarchy efficiently, among the memory hierarchy, such as registers, caches (primary, secondary), memory and disk, the optimization is conducted to efficiently use registers. The optimization can also be conducted to use caches efficiently by changing the sequence of an execution order.

Important optimization in compiler is for loops. Several loops can be optimized to improve execution time.

As a conventional program optimization method, it has been suggested that search and analysis are conducted inside of a system program, a determination is made about whether symbols (variables) in source code are used or unused, and optimization is conducted on symbols (variables) that are identified as unused. For example, see Patent Literature 1.

With respect to a system program of a numerical controller, there is also technology of optimizing unnecessary branch commands for unused functions based on a history of the use of the functions during executing a machining program. For example, see Patent Literature 2.

### PRIOR ART DOCUMENT

### Patent Literature

[Patent Literature 1] Japanese Patent Laid-Open Publication No. 2000-207226
[Patent Literature 2] Japanese Patent Laid-Open Publication No. 2016-133911

### SUMMARY OF THE INVENTION

### Problems to be Solved by the Invention

Numerical controllers are not devices dedicated for one machine tool, but are general-purpose devices which can be applied to multiple machine tools. Thus, in a system program for a numerical controller, unnecessary source code and symbols (variables) may be generated depending on a system configuration of the numerical controller, machine tools, and external devices. Conventionally, the methods disclosed in Patent Literatures 1 and 2, for instance, were used to optimize the system program.

However, even if the system program is analyzed as taught in Patent Literature 1, it cannot be determined what kind of external input signals will be input. Furthermore, even if the optimization is conducted on each function as taught in Patent Literature 2, more detailed external input signals within the function cannot be optimized.

Thus, technology for optimizing system programs is desired in the field of numerical controller.

### Means for Solving the Problem

One aspect of the present disclosure is a system program optimization device for managing a system program for a numerical controller that includes: a constant value acquisition unit that acquires a constant value set for an external input signal input from an external device which is connected to the numerical controller; and a compiler that translates source code of the system program into an object program that can be executed by the numerical controller, wherein the compiler includes an optimization unit that optimizes the system program by using the constant value of the external input signal.

One aspect of the present disclosure is a system program optimization system that includes: an information processing device that includes a constant value setting unit that accepts a setting of a constant value for an external input signal input from an external device which is connected to a numerical controller, and a constant value output unit that outputs the constant value to a system program optimization device; and a system program optimization device for managing a system program for a numerical controller that includes a constant value acquisition unit that acquires a constant value set for an external input signal input from the external device connected to the numerical controller, and a compiler that translates source code of the system program into an object program that can be executed by the numerical controller, wherein the compiler includes an optimization unit that optimizes the system program by using the constant value of the external input signal.

One aspect of the present disclosure is a storage medium that stores instructions readable by one or more processors, the one or more processors executing the instructions to: acquire a constant value set for an external input signal input from an external device which is connected to a numerical controller; compile source code of a system program of the numerical controller into an object program that can be executed by the numerical controller; and optimize the system program by using the constant value of the external input signal in the compiling process.

### Effect of the Invention

One aspect of the present invention can optimize system programs.

### BRIEF DESCRIPTION OF THE DRAWINGS

FIG. 1 is a conceptual diagram of a system program optimization system;

FIG. 2 illustrates a system program;

FIG. 3 illustrates a system program;

FIG. 4 is a block diagram showing the system program optimization system;

FIG. 5 shows an example of a constant value setting screen;

FIG. 6 shows an example of a constant value setting screen;

FIG. 7 shows a hardware configuration of a numerical controller;

FIG. 8 shows a configuration of a complier;

FIG. 9 shows examples of source code and constant values of macro variables;

FIG. 10 shows changes in the source code by optimization;

FIG. 11 is a flowchart illustrating processing of setting a constant value of an external input signal;

FIG. 12 shows a relationship between indices and the macro variables;

FIG. 13 is a flowchart of processing of reading the constant value and conducting the optimization; and

FIG. 14 shows a hardware configuration of a system program optimization device.

### MODE FOR CARRYING THE INVENTION

### First Embodiment

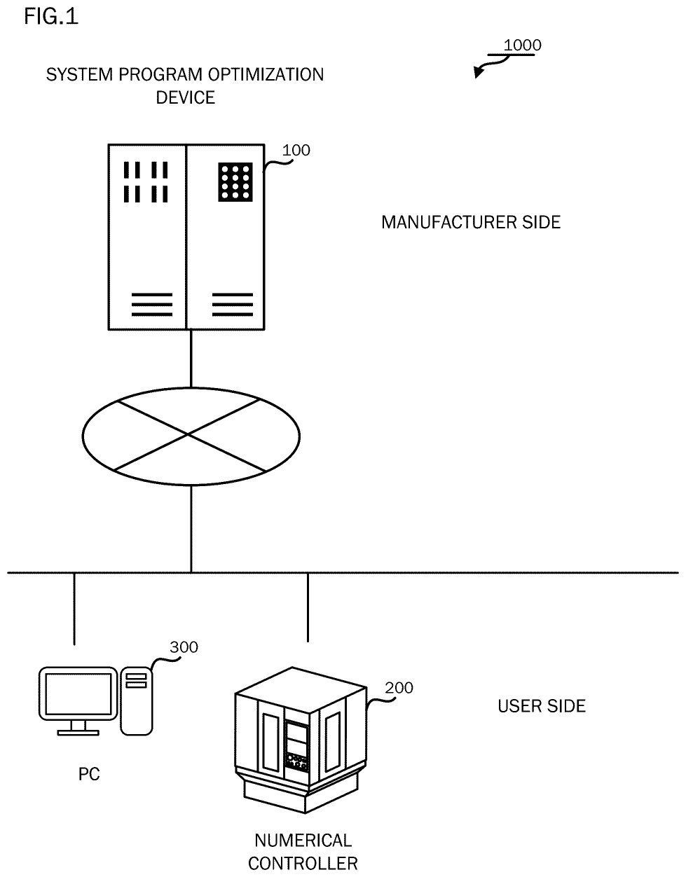

A description will now be made about a system program optimization system 1000 according to a first embodiment. FIG. 1 is a conceptual diagram of the system program optimization system 1000.

The system program optimization system 1000 consists of a server as a system program optimization device 100, a numerical controller 200 that uses a system program, and an information processing device 300 (PC: including a personal computer) that is connected to the numerical controller 200.

The system program optimization device 100 is configured to provide a system program to a user of the numerical controller 200.

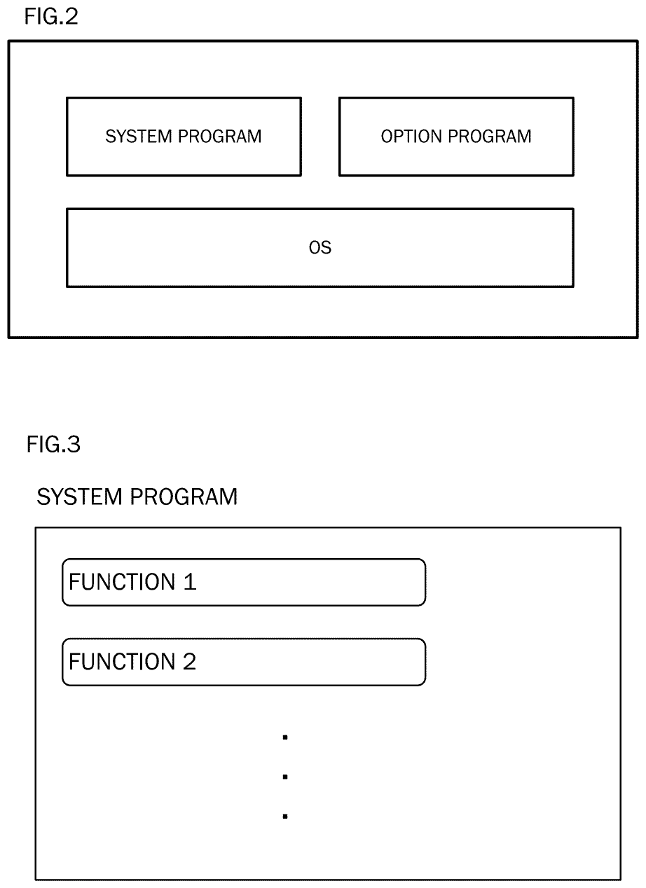

The system program is a basic program for the numerical controller 200 (FIG. 2). The system program is for controlling basic operations of the numerical controller 200, such as storing machining programs, editing the machining programs, executing the machining programs, controlling and monitoring axis movements and peripheral devices, storing tool offset data, editing the tool offset data, correcting tool sizes, managing tools, managing workpieces, measuring the workpieces, monitoring operating statuses, collecting state information, performing synchronous control with the external devices (data exchange during tool exchange), and carrying in and out workpieces, managing jobs (cooperative activities between the numerical controller, robots, a PLC and others).

As shown in FIG. 3, the system program includes programs for executing the above-described basic functions. The numerical controller 200 is a general-purpose device that can be applied to various types of machine tools. All functions are inclusively written in an original system program. The original system program has redundant code so that it can be compatible with the various machine tools and the peripheral devices. If the original system program is used without being processed, unnecessary computation increases and computation efficiency is decreased. The system program optimization device 100 acquires a constant value of an external input signal from a user to optimize the system program, thereby improving the computation efficiency of the numerical controller 200.

The system program optimization device 100 collectively manages the system programs for multiple numerical controllers 200. The system program optimization device 100 of a numerical controller manufacturer is connected to the information processing device 300 of a numerical controller user via an external network. The system program optimization device 100 optimizes, for instance, source code of an original system program based on the type of the numerical controller 200, the type of a machine tool, the functions of the numerical controller 200 used by the user, a constant value of an external input signal from an external device connected to the numerical controller 200. The manufacturer of the numerical controller 200 provides the user with an optimized system program for each numerical controller 200.

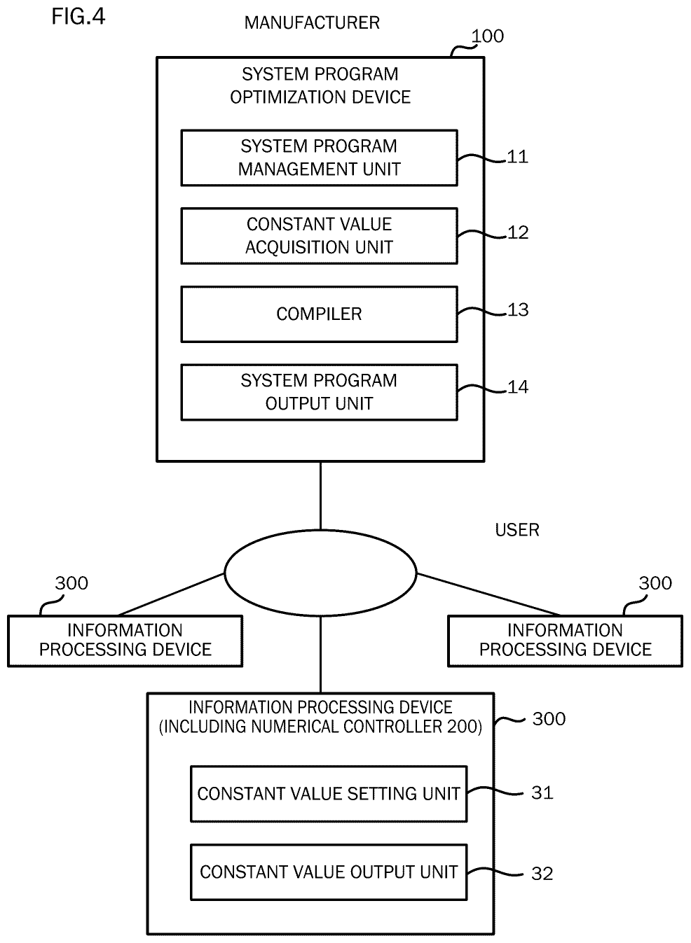

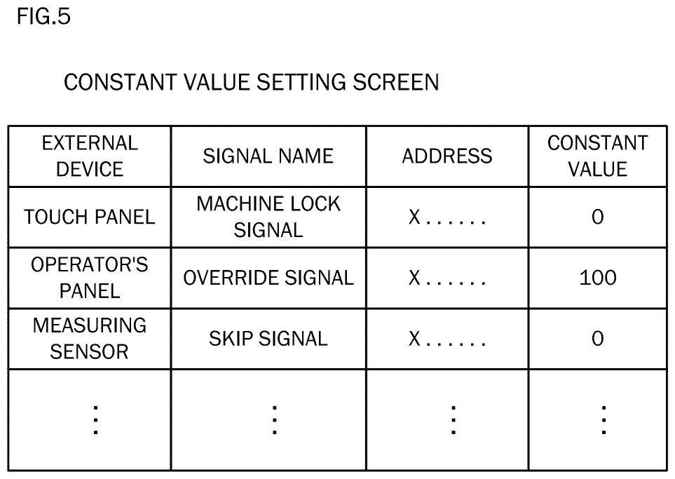

FIG. 4 is a block diagram of a system program optimization system 1000.

The information processing device 300 on the user side (including the numerical controller 200) has a constant value setting unit 31 and a constant value output unit 32.

The constant value setting unit 31 is configured to accept the setting of a constant value of an external input signal from the user. FIG. 5 shows an example of a constant value setting screen. The constant value setting screen in FIG. 5 shows a list of the names of the external devices that output external input signals, the name of the external input signals and the addresses of the external input signals. The user refers to the names of the signals to input their constant values.

The constant value setting unit 31 shows the above-described list of the external input signals and accepts the constant value settings of the external input signals.

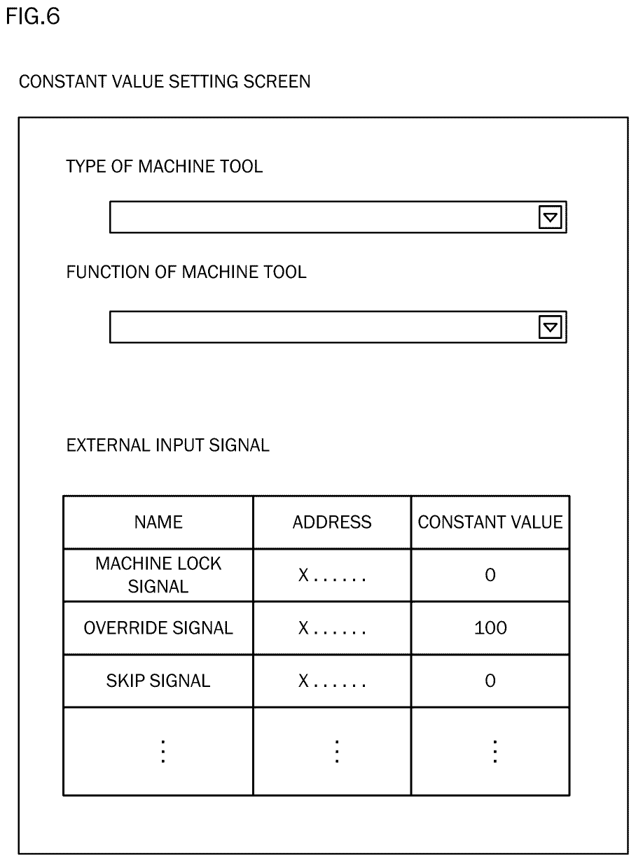

FIG. 6 shows another example of the constant value setting screen. The constant value setting screen in FIG. 6 allows the user to designate the type of a machine tool and a function of the machine tool, and accepts the input of a constant value of an external input signal relating to the designated machine tool and function.

The configuration of the constant value setting screen is not limited to those shown in FIGS. 5 and 6. The constant value setting screen may provide addresses assigned to terminals of an I/O unit and the like, about which will be described later, constant values of signals to be input to the terminals, and indices corresponding to the set external input signals. The content of each external input signal changes depending on the mode and the operating status of the numerical controller 200. The address and the constant value of each external input signal may be set in association with the mode and the operating status of the numerical controller 200.

The constant value output unit 32 outputs an index corresponding to an external input signal and its constant value set by the user to the system program optimization device 100.

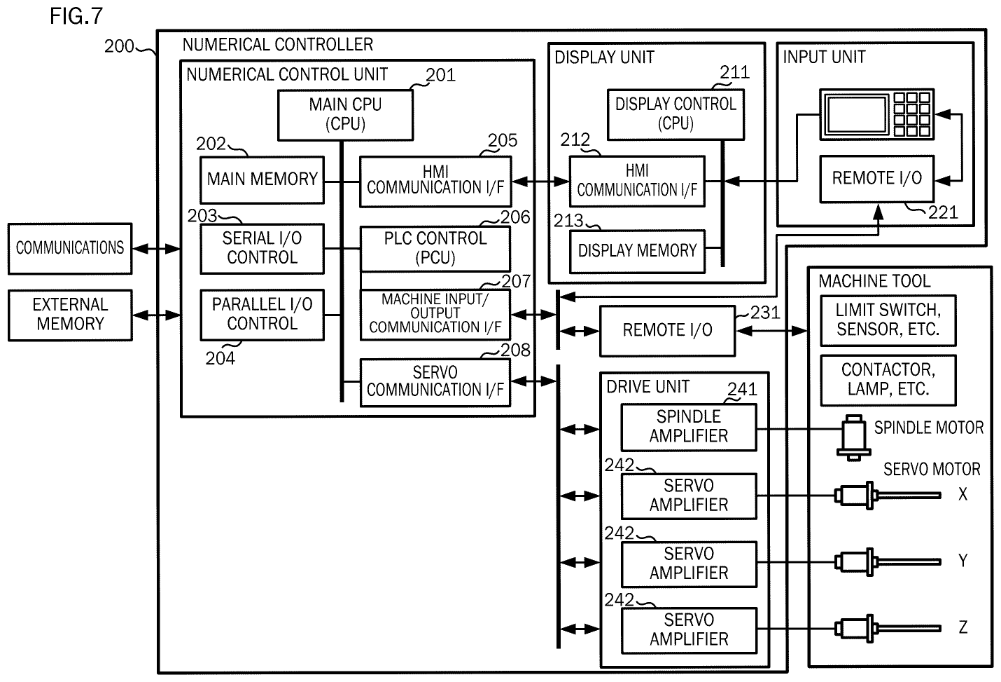

Next, an example of the external devices connected to the numerical controller 200 will be described. FIG. 7 shows an example of a hardware configuration of the numerical controller 200.

The numerical controller 200 includes, for example, a main CPU 201, a main memory 202, a serial I/O control unit 203, a parallel I/O control unit 204, an HMI (Human Machine Interface)-type communication I/F 205, a PLC control unit (CPU for PLC) 206, a machine input/output communication I/F 207, and a servo communication I/F 208.

The numerical controller 200 is connected to a display unit via the HMI-type communication I/F 205 and further to an input unit of a touch panel, an operator's panel or similar via the display unit. The input to the touch panel, the operator's panel or similar is output to the numerical controller 200 via a remote I/O 221.

The numerical controller 200 includes the machine input/output communication I/F 207. The machine input/output communication I/F 207 inputs and outputs signals to and from a limit switch, a sensor, a contactor, a lamp and others of a machine tool via the remote I/O unit 231. The numerical controller 200 is connected to a spindle amplifier 241 and a servo amplifier 242 via the servo communication I/F 208. The numerical controller 200 acquires signals of a spindle motor and a servo motor via the servo communication I/F 208.

The numerical controller 200 includes the PLC control unit 206. The PLC control unit 206 acquires signals from the sensors and devices incorporated in the numerical controller 200. In this disclosure, signals from the devices incorporated in the numerical controller 200, such as the operator's panel and the sensors, are also called external input signals.

Next, the system program optimization device 100 will be described.

As shown in FIG. 4, the system program optimization device 100 includes a system program management unit 11, a constant value acquisition unit 12, a compiler 13 and a system program output unit 14.

The system program management unit 11 is configured to collectively manage system programs for multiple users' numerical controllers 200. The system program management unit 11 manages, for instance, a system program customized for each numerical controller 200, such as identification information of each numerical controller 200, and a constant value of an external input signal set for each numerical controller 200.

The constant value acquisition unit 12 is configured to acquire the constant values of the external input signals from the user's information processing device 300 (including the numerical controller 200).

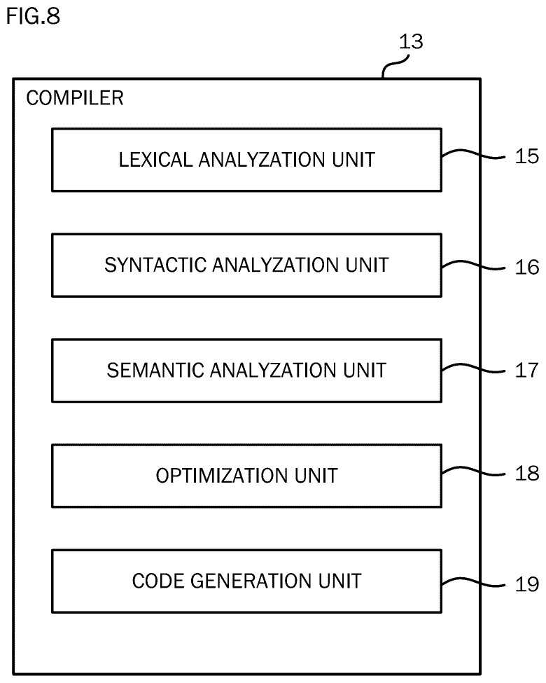

The compiler 13 is configured to convert source code of a system program written in a high-level language into an object program that can be interpreted/executed by the numerical controller 200. The compiler 13 includes, as shown in FIG. 8, a lexical analyzation unit 15, a syntactic analyzation unit 16, a semantic analyzation unit 17, an optimization unit 18 and a code generation unit 19.

The lexical analyzation unit 15 is configured to breaks a source code string into a sequence of language elements (tokens).

The syntactic analyzation unit 16 is configured to transform the sequence of tokens into a structure that reflects their meanings. This structure is often represented as a tree structure and called an abstract syntax tree.

The semantic analyzation unit 17 is configured to conduct semantic analyzation on a syntactic tree. The semantic analyzation enables the conversion of the source code into intermediate code.

The optimization unit 18 is configured to transform the intermediate code to convert it into an efficient program. The optimization unit 18 of the present disclosure performs optimization by using the constant value of the external input signal to reduce the number of instruction executions. The procedure performed by the optimization unit 18 will be described later.

The code generation unit 19 is configured to translate an internal code into a language used in an object program. For example, the code generation unit 19 translates the intermediate code into an assembly language for the numerical controller 200.

The system program output unit 14 is configured to output the system program optimized by using the constant value of the external input signal to the information processing device 300 (including a numerical controller 200).

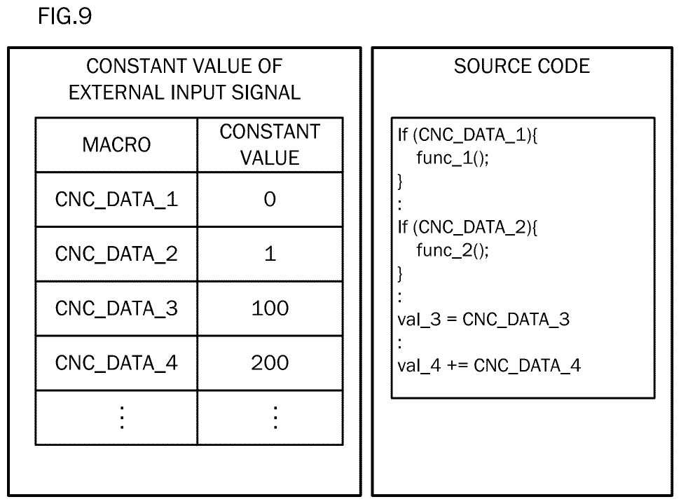

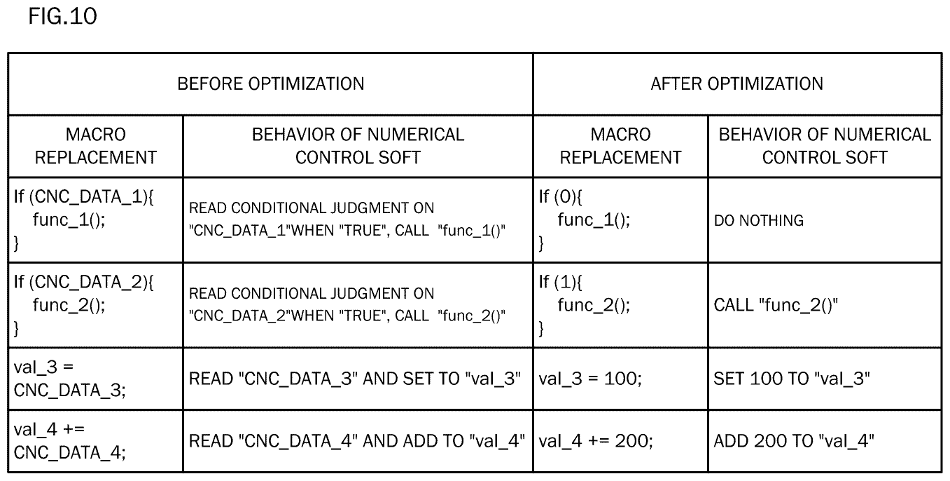

With reference to FIGS. 9 and 10, the optimization using the constant values will be described.

FIG. 9 shows an example of source code and constant values of macro variables, and FIG. 10 shows the change in the source code after the optimization.

As shown in FIG. 9, a constant value “0” is set to a macro variable “CNC_DATA_1”, a constant value “1” is set to a macro variable “CNC_DATA_2”, a constant value “100” is set to a macro variable “CNC_DATA_3”, and a constant value “200” is set to a macro variable “CNC_DATA_4”.

The source code includes functions “If (CNC_DATA_1) {func_1 ( )}:” and “If (CNC_DATA_2) {func_2 ( )}:”, and equations “val_3=CNC_DATA_3:” and “val_4+=CNC_DATA_4:”.

With reference to FIG. 10, the change in the source code after the optimization will be described.

Function in the first line: when the function “If (CNC_DATA_1) {func_1 ( )}:” before the optimization is executed, the numerical controller reads an external input signal corresponding to the macro variable “CNC_DATA_1” from the memory, conducts conditional judgment, and when the result of the conditional judgment is “true”, calls the function “func_1( ).

When a constant value “0” is assigned to the macro variable “CNC_DATA_1” through the optimization, the function becomes “If(0){func_1( )}, and a conditional statement is always “false”, so that the concerned function becomes a dead instruction and can be deleted. The numerical controller does nothing with this code.

Function in the second line: when the function “If (CNC_DATA_2) {func_2( )}:” before the optimization is executed, the numerical controller reads an external input signal corresponding to the macro variable “CNC_DATA_2” from the memory, conducts conditional judgment, and when the result of the conditional judgment is “true”, calls the function “func_2( ).

When a constant value “1” is assigned to the macro variable “CNC_DATA_2” through the optimization, the function becomes “If(1){func_2( )}, and a conditional statement is always “true”, so that conditional branching is not necessary. Furthermore, since the macro variable “CNC_DATA_2” is a constant, it is not necessary to read in the external input signal.

Function in the third line: the equation “val_3=CNC_DATA_3;” before the optimization is executed, the numerical controller reads an external input signal corresponding to the macro variable “CNC_DATA_3” from the memory and assigns to the variable “val_3”.

When a constant value “100” is assigned to the macro variable “val_3” through the optimization, it is not necessary to read in the external input signal.

Function in the fourth line: the equation “val_4+=CNC_DATA_4;” before the optimization is executed, the numerical controller reads an external input signal corresponding to the macro variable “CNC_DATA_4” from the memory and adds to the variable “val_4”.

When a constant value “200” is assigned to the macro variable “val_4” through the optimization, the value “200” is added to the variable “val_4” without reading in the external input signal.

The above-described optimization can reduce the number of instruction executions.

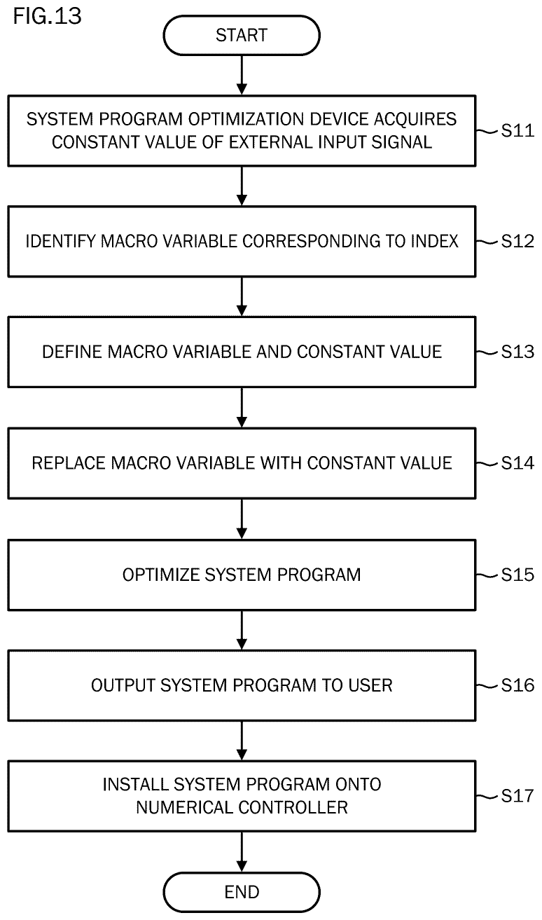

Next, with reference to FIGS. 11 and 13, operations of the system program optimization system 1000 of the present disclosure will be described. FIG. 11 is a flowchart showing processing of setting a constant value of an external input signal, and FIG. 13 is a flowchart showing optimization processing.

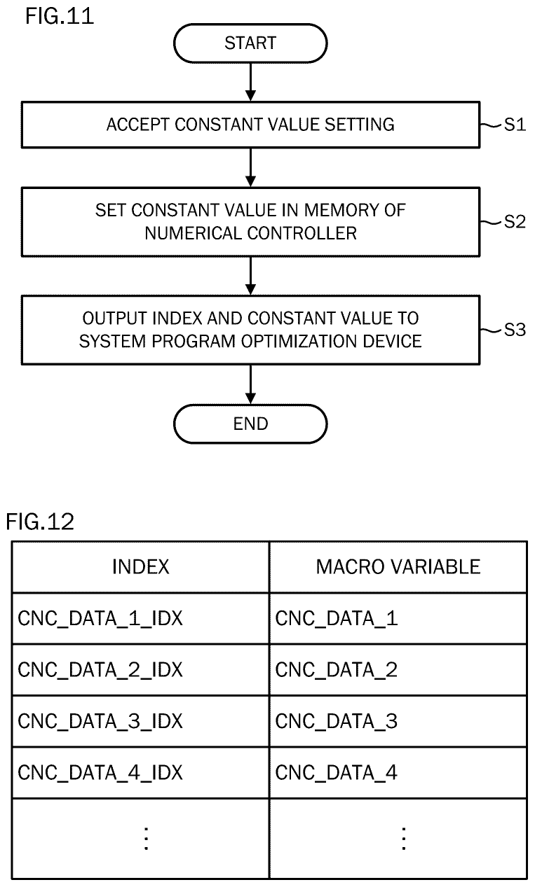

The constant value setting unit 31 accepts the setting of a constant value of an external input signal from a user (step S1). The constant value of the external input signal is associated with an index and an address on a memory which correspond to the external input signal. The index is associated with a macro variable. FIG. 12 shows an example in which macro variable such as “CNC_DATA_1”, “CNC_DATA_2”, “CNC_DATA_3” and “CNC_DATA_4” are tied to indices such as “CNC_DATA_1_IDX”, “CNC_DATA_2_IDX”, “CNC_DATA_3_IDX” and “CNC_DATA_4_IDX”, respectively. The indices are associated with the macro variables by the system program optimization device.

The constant value setting unit 31 sets the constant value specified by the user in a memory of the numerical controller 200 (step S2).

The constant value output unit 32 outputs the constant value and the index to the system program optimization device 100 (step S3).

By referring to FIG. 13, the optimization processing will be described.

The constant value acquisition unit 12 of the system program optimization device 100 acquires the index and the constant value of the external input signal (step S11). The constant value acquisition unit 12 identifies a macro variable that corresponds to the index of the external input signal (step S12). The constant value acquisition unit 12 defines the macro variable with the constant value of the external input signal (step S13).

The optimization unit 18 replaces the macro variable with the constant value (step S14). The optimization unit 18 optimizes a system program (step S15). The system program output unit 14 identifies the user based on information managed by the system program management unit 11 and outputs the system program to the information processing device (including the numerical controller 200) of the user (step S16).

The user installs the acquired system program onto the numerical controller 200 (step S17).

As described above, the system program optimization system 1000 of the present disclosure includes the system program optimization device 100. The system program optimization device 100 manages the system program for the numerical controller 200 through a network. The system program optimization device 100 conduct the optimization on the system program by using the constant value of the external input signal acquired from the user. The user installs the optimized system program onto his/her numerical controller 200.

### Second Embodiment

A specific example of the external input signal will be described.

The example of the external input signal according to a second embodiment is a machine lock signal. When the machine lock signal is on, the numerical control device 200 goes into a machine lock state. In the machine lock state, a machine tool is not actually moved even when a move instruction is executed, but only position display update is performed. Normally, a main CPU 201 accesses the machine lock signal every control cycle to determine whether the machine tool is in the machine lock state (the machine lock signal is on).

In a case where the optimization is conducted by setting the machine lock signal to off (constant value), the main CPU 201 can determine without accessing the machine lock signal that the machine tool is not in the machine lock state. Thus, a waiting time in a control cycle for acquiring the external input signal is reduced, and furthermore the time to process a branch for determining the machine lock state is reduced.

### Third Embodiment

An example of the external input signal according to a third embodiment is a feedrate override signal. The feedrate override signal represents a numerical value for adjusting a feedrate and a rotation speed during machining. The feedrate override signal is normally at a constant rate (100%) and can be specified in the range of 0 to 200%, for instance. The main CPU 201 usually accesses the feedrate override signal in the control cycle during machining, and reads a value of the feedrate override signal from the memory to control the feedrate.

When the optimization is conducted by setting the feedrate override signal to 100% (constant value), the main CPU 201 controls the feedrate to be constant without accessing the feedrate override signal. Thus, the waiting time in the control cycle for acquiring the external input signal is reduced.

### Fourth Embodiment

An example of the external input signal according to a fourth embodiment is a skip signal. When the skip signal is on, the main CPU 201 proceeds to the next block (next line in a machining program) when the signal is input even if the block being executed (one line of the machining program) is not completed. When the skip signal is on, the main CPU 201 typically accesses the skip signal in a control cycle, skips the block being executed currently, and reads the next block.

In a case where the optimization is conducted by setting the skip signal to off, the main CPU 201 executes the machining program without accessing the skip signal. Thus, a waiting time in the control cycle for acquiring an external input signal is reduced.

As described above, the system program optimization system 1000 of the present disclosure allows the user to set the constant value of the external input signal, and uses the set constant value to optimize the system program. The optimization enables the reduction of a time of accessing the external input signal for each control signal and the reduction of branching instructions, constant convolution and so on, thereby improving execution efficiency. Furthermore, if unexecuted functions are disabled, redundant code for unnecessary functions can be removed, so that the execution efficiency is improved.

Although the external input signal has a risk of malfunction due to the change in a voltage level caused by noise, the constant value is set so as to prevent the occurrence of the malfunction caused by the noise. Since the malfunction is not caused by the noise by setting the constant value, costs of anti-noise elements can also be reduced.

The optimization of the system program can reduce a coding region and a data area to be used for processing the external input signal. Thus, memory capacity to be used for running the system program can be reduced, and thereby a load on hardware can be reduced.

The second to fourth embodiments present the examples of using the signal from the input unit, such as a touch panel or an operator's panel. In addition to that, as shown in FIG. 6, the external input signal to be input to the numerical controller 200 includes signals input from other external devices (e.g. a limit switch, a sensor, a contactor, a lump, a spindle motor, a servo motor).

In the first embodiment, the system program optimization device 100 acquires the constant value of the external input signal through the network. Alternatively, the constant value may be acquired through a portable memory medium.

There has been technology to optimize a system program by analyzing the specification and the source code of the system program of the numerical controller 200. In the conventional technology, the system program of the numerical controller 200 is optimized based on a user specification. However, the present disclosure can promote further optimization to suit to the environment of user's actual usage.

### <Hardware Configuration>

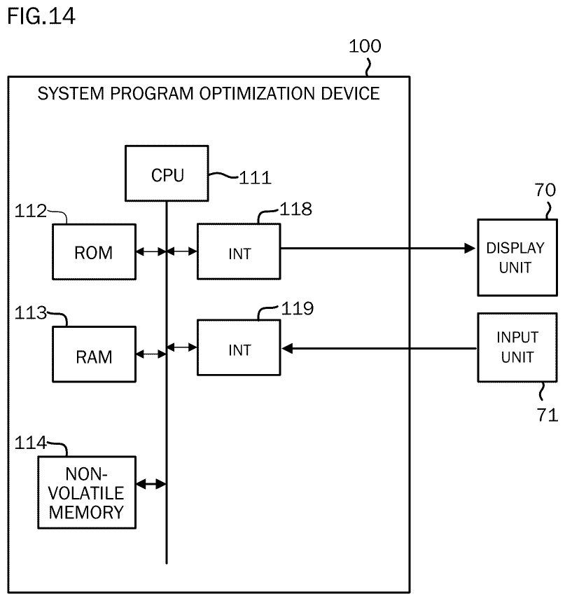

With reference to FIG. 14, a hardware configuration of the system program optimization device 100 will be described. The system program optimization device 100 includes a central processing unit (CPU) 111 that is a processor for controlling the entire system program optimization device 100. The CPU 111 reads an operating program processed in a read-only memory (ROM) 112 via a bus to control the entire system program optimization device 100 according to the operating program. A random-access memory (RAM) 113 is configured to temporarily store temporary computation data and pieces of data to be displayed, as well as various pieces of data input by a user through an input unit 71.

A display unit 70 is a monitor attached to the system program optimization device 100.

The input unit 71 is a keyboard, a touch panel, an operating button or similar which is integral with the display unit 70 or separate from the display unit 70. The user operates the input unit 71 to perform an input operation to a screen displayed on the display unit 70.

A non-volatile memory 114 is, for example, a memory which is backed up by a battery not shown, so that storage conditions can be retained even when a power source of the system program optimization device 100 is turned off. The non-volatile memory 114 is configured to store management information on the system program. The management information on the system program includes, for example, identification information of the numerical controller, constant values of external input signals. The non-volatile memory 114 stores programs read from an external device via an interface not shown, programs input through the input unit 71, and various data acquired from each component of the system program optimization device 100. The programs and the various data stored in the non-volatile memory 114 may be deployed into the RAM 113 when they are executed/used. Furthermore, the ROM 112 stores various system programs in advance.

### REFERENCE SIGNS LIST

1000 System Program Optimization System
100 System Program Optimization Device
11 System Program Management Unit
12 Constant Value Acquisition Unit
13 Compiler
14 System Program Output Unit
18 Optimization Unit
200 Numerical Controller
300 Information Processing Device
31 Constant Value Setting Unit
32 Constant Value Output Unit
70 Display Unit
71 Input Unit
111 CPU
112 ROM
113 RAM
114 Non-Volatile Memory

1. A system program optimization device for managing a system program for a numerical controller, comprising:
a constant value acquisition unit that acquires a constant value set for an external input signal input from an external device which is connected to the numerical controller; and
a compiler that translates source code of the system program into an object program that can be executed by the numerical controller,
wherein the compiler comprises an optimization unit that optimizes the system program by using the constant value of the external input signal.

2. The system program optimization device according to claim 1, wherein the constant value acquisition unit acquires an index that is associated with an address of the external input signal in a memory of the numerical controller, and determines variables in the system program based on the index.

3. The system program optimization device according to claim 1, comprising a system program management unit that manages system programs of a plurality of numerical controllers, and a system program output unit that outputs the system program optimized by using the constant value to an information processing device of a user.

4. The system program optimization device according to claim 1, wherein an original system program is a general-purpose program that can be adapted to the plurality of numerical controllers, and
the optimization unit optimizes the original system program for a numerical controller of the user.

5. A system program optimization system, comprising:
an information processing device, comprising
a constant value setting unit that accepts setting of a constant value for an external input signal input from an external device which is connected to a numerical controller, and
a constant value output unit that outputs the constant value to a system program optimization device; and
a system program optimization device for managing a system program of a numerical controller, comprising
a constant value acquisition unit that acquires a constant value set for an external input signal input from the external device connected to the numerical controller, and
a compiler that translates source code of the system program into an object program that can be executed by the numerical controller,
wherein the compiler comprising an optimization unit that optimizes the system program by using the constant value of the external input signal.

6. A storage medium which stores instructions readable by one or more processors,
the one or more processors executing the instructions to:
acquire a constant value set for an external input signal input from an external device which is connected to a numerical controller;
compile source code of a system program of the numerical controller into an object program that can be executed by the numerical controller; and
optimize the system program by using the constant value of the external input signal in the compiling process.
